(19) United States
(12) Patent Application Publication
(10) Pub. No.: US 2022/0105761 A1
(43) Pub. Date: Apr. 7, 2022

(54) Boat with Foot Pedal Operated Braking System

(71) Applicant: Hall Labs LLC, Provo, UT (US)

(72) Inventors: Stephen Hall, Provo, UT (US); David R. Hall, Provo, UT (US)

(73) Assignee: Hall Labs LLC, Provo, UT (US)

(21) Appl. No.: 17/490,629

(22) Filed: Sep. 30, 2021

Related U.S. Application Data
(60) Provisional application No. 63/087,099, filed on Oct. 2, 2020.
(60) Provisional application No. 63/087,110, filed on Oct. 2, 2020.

(51) Int. Cl. B60F 3/00; B63H 25/02; B63C 13/00; B63B 1/04

(52) U.S. Cl. CPC B60F 3/003; B63H 25/02; B63H 2025/022; B63C 13/00; B63B 1/04; B60F 3/0007

(57) ABSTRACT

A boat comprising a hull, a steering wheel, an engine power system comprising a first foot pedal that is operated by a user's foot to control the boat's speed through water, and a braking system comprising a second foot pedal that is depressed by the user's foot to slow or stop the boat.

### CROSS-REFERENCE TO RELATED APPLICATIONS

This application claims priority to U.S. Provisional Patent Application Ser. No. 63/087,099 titled “Self Trailered Boat” and U.S. Provisional Patent Application Ser. No. 63/087,110 titled “Boat with Foot Pedal Operated Braking System” filed on Oct. 2, 2020, which are incorporated herein by reference in their entirety.

### TECHNICAL HELD

The present disclosure relates to boats. More particularly, it relates to a boat that can be towed without the need for a trailer.

### BACKGROUND

To move a boat from one location to another, such as from a residential home to a body of water, the boat is typically loaded on a trailer. The trailer comprises a coupler so that the trailer can be connected to a hitch of a vehicle and towed by a user to a desired location. Multiple time-consuming steps are required for a user to launch the trailered boat into the water. These steps include backing a portion of the trailer down a ramp and into the water, disconnecting the boat from the trailer and sliding it off of the trailer and into the water, moving the boat to a docked and secure location, and moving the trailer out of the water and back up the ramp to another location such as a parking lot. These steps are then done in reverse when it is time to take the boat out of the water and return home. Naturally, these steps are usually time consuming, especially if carried out by a single user.

### SUMMARY

In a first aspect of the invention, a boat comprises a hull, a steering wheel, an engine power system comprising a first foot pedal that is operated by a user's foot to control the boat's speed through water, and a braking system comprising a second foot pedal that is depressed by the user's foot to slow or stop the boat.

In another aspect of the invention, the braking system of the boat further comprises a moveable shroud that is moved over a jet drive outlet or a propeller to reverse water flow and slow or stop the boat. The moveable shroud may be operated by the second foot pedal. The distance the second foot pedal is depressed determines the amount of reverse water flow is produced by the moveable shroud. Removing the user's foot from the first foot pedal may stop the engine power system,

In a still further aspect, a towable boat comprises a hull, a front wheel movable between an extended position and a retracted boating position, two rear wheels, each of which is movable between an extended towing position and a retracted boating position, a motor to drive at least one of the front or two rear wheels, whereby the boat can be taxied to a spot where it enters the water, and a brake foot pedal, operating both a first brake system to slow or stop the boat when taxiing and a second brake system to slow or stop the boat when boating.

In a yet still further aspect, the first and second brake systems of the towable boat are automatically selected depending on whether the boat is taxiing or boating.

In another aspect, the first brake system of the towable boat is selected when the front and rear wheels are in the extended position and the second brake system is selected when the front and rear wheels are in the retracted position.

In another aspect of the invention, the towable boat further comprises an impeller for moving the boat in water and an accelerator foot pedal for controlling the speed of the impeller. When downward pressure on the accelerator foot pedal is released, the impeller may be stopped.

In still another aspect, rotation of the front wheel of the towable boat can be stopped by the braking system.

In a still further aspect, towable boat further comprises a trailer tongue movable between an extended towing position and a retracted boating position. The towable boat further comprises a cavity in the hull so that the trailer tongue can retract into the cavity.

In a still yet further aspect, at least one of the wheels of the towable boat is configured to be rotated by a motor to thereby propel the boat when taxiing.

In another still yet further aspect, the front wheel of the towable boat is steerable.

In another aspect of the invention, the braking system of the towable boat comprises a moveable shroud that can be moved over a jet drive outlet or a propeller to redirect water flow to reverse water flow and slow or stop the boat when boating. The moveable shroud can be controlled by actuating the brake foot pedal. The distance the brake foot pedal is depressed determines the amount of reverse water flow is produced by the moveable shroud.

In still another aspect, the hull of the towable boat comprises aluminum.

In a still further aspect, the towable boat is fabricated by a tab and slot method.

Further aspects and embodiments are provided in the foregoing drawings, detailed description, and claims. Unless specified otherwise, the features as described herein are combinable and all such combinations are within the scope of this disclosure.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 illustrates a side view of a self trailered boat with the wheels down, according to an embodiment of the disclosure.

FIG. 2 illustrates a side view of a self trailered boat with the wheels retracted, according to an embodiment of the disclosure.

FIG. 3 illustrates an overhead view of a self trailered boat, according to an embodiment of the disclosure.

FIG. 4 illustrates a front view of a self trailered boat, according to an embodiment of the disclosure.

FIG. 5 illustrates a rear view of a self trailered boat, according to an embodiment of the disclosure.

FIG. 6 illustrates a view of a trailer tongue for a self trailered boat, according to an embodiment of the disclosure.

FIG. 7 illustrates the cockpit area of a self trailered boat, according to an embodiment of the disclosure.

FIG. 8 illustrates a close-up of a jet drive motor in forward and reverse operation, according to an embodiment of the disclosure.

FIG. 9 illustrates a view of a self trailered boat hitched to a vehicle, according to an embodiment of the disclosure.

FIG. 10 illustrates a self trailered boat in taxiing mode, according to an embodiment of the disclosure.

FIG. 11 illustrates a self trailered boat in boating mode, according to an embodiment of the disclosure.

FIG. 12 illustrates a self trailered boat with an expanded sunshade, according to an embodiment of the disclosure.

### DETAILED DESCRIPTION

### Overview

Embodiments of methods, devices and processes described herein are directed towards a boat that can be towed from one location to another without the need for a trailer. The boat is designed so it is much easier for a user to transport the boat to a body of water, enter the body of water and leave the body of water.

The disclosure herein describes a boat with a foot pedal operated braking system. The boa includes an engine power system comprising a first foot pedal that is operated by a user's foot to control the boat's speed through water and a braking system comprising a second foot pedal that is depressed by the user's foot to slow or stop the boat. Multiple methods are disclosed to slow or stop the boat using the second foot pedal.

### Definitions

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the term “user” refers to any individual who uses a towable boat.

As used herein, the term “boat” refers to a small vessel propelled on water by oars, sails, or an engine.

As used herein, the term “trailer” refers to a platform for transporting a boat. The trailer comprises a device, such as a trailer coupler, to connect to a hitch mounted to a vehicle to transport a boat.

As used herein, the term “hitch” refers to a device for attaching one thing to another.

As used herein, the term “hull” refers to the main body of a ship or other vessel, including the bottom, sides, and deck but not the masts, superstructure, rigging, engines, and other fittings.

As used herein, the term “gunwale” refers to the top edge of the hull of a boat.

As used herein, the term “cleat” refers to a T-shaped piece of metal or wood on a boat to which ropes are attached.

As used herein, the term “bow” refers to the front end of a boat.

As used herein, the term “stern” refers to the back or aft-most part of a boat.

As used herein, the terra “port” refers to the left side of a boat.

As used herein, the term “starboard” refers to the right side of a boat.

As used herein, the term “cockpit” refers to a sunken space in the deck of a boat for use by the user. The cockpit may also comprise the “helm” which is the location for a user to drive the boat.

As used herein, the term “suspension” refers to the system of tires, tire air, springs, shock absorbers and linkages that connects a towable boat to its wheels and allows relative motion between the two.

As used herein, the term “paddle tire” refers to a tire that is specifically designed for use in sandy and muddy conditions. Typically, a paddle tire consists of a smooth tire core which has a series of large rubber cups (or paddles) attached to it. The volume inside of the paddles is much larger than the void of a knobby tire, so it is unlikely to clog up with sand/mud.

As used herein, the term “parked mode” refers to the mode where the boat is sitting idle, such as at the user's residence.

As used herein, the term “towing mode” refers to the mode where the boat is being pulled by a towing vehicle, such as the user's car or truck.

As used herein, the term “taxiing” or “taxiing mode” refers to the mode where the boat is moving, preferably under its own power, between either (a) the spot where it is hitched and/or unhitched to the towing vehicle and the spot where it enters and/or leaves the water, or (b) between the spot where it is stored to the spot where it is hitched and/or unhitched to the towing vehicle.

As used herein, the term “boating” or “boating mode” refers to the mode where the boat is moving through water.

As used herein, the term “jet drive” refers to a type of boat engine that uses the power of waterjet propulsion to move a boat through water. The waterjet works by generating a propulsive thrust, created when water is forced or ‘sucked in’ to the jet unit and forced out a waterjet outlet, which propels the boat forward.

As used herein, the term “wheel hub motor” refers to an electric motor that is incorporated into the hub of a wheel and drives it directly.

### Exemplary Embodiments

The present disclosure relates to self trailered boats, The present disclosure discloses a self trailered boat which is a boat capable of being towed from one location to another without the need of a conventional boat trailer. Users may be able to unhitch a boat from a towing vehicle and place the boat into a body of water much faster than conventional methods of backing a trailered boat into water, releasing the boat from the trailer, moving the boat to a dock, then moving the towing vehicle and trailer to a parking location.

In various exemplary embodiments, the self trailered boat comprises a retractable front wheel and two retractable rear wheels. The wheels may be retracted into wheel cavities that can be closed when using the boat in a body of water. The wheels may be extended out of the wheel cavities when the boat is to be towed. Only the front wheel may be retracted while the rear wheels are extended in towing mode.

In other various exemplary embodiments, the boat comprises a foot pedal braking system wherein when the pedal is initially depressed by the foot of a user the engine power to the boat is cut. As the pedal is further depressed, a shroud slides over the jet outlet, the engine power is reapplied and the jet of water is diverted towards the front of the boat in a reverse direction which brings the boat to a stop and eventually able to move the boat in reverse.

In other various embodiments, the boat comprises an extendable trailer tongue that can be extended from the hull of the boat and retracted into the hull of the boat. The trailer tongue can be extended and hitched to a towing vehicle to tow the boat. The trailer tongue can be retracted into the hull when the boat is being taxied in taxiing mode or when in boating mode when the boat is in the water. When extended, the trailer tongue may be articulated in various ways and directions for ease of hitching to a towing vehicle.

In various embodiments, a tab and slot method of fabrication may be used to assemble the self trailered boat, providing an efficient and precise way to build the boat. Further, non-additive laser welding may be used to produce high quality welds, to speed up manufacturing, and to aide automation.

### Self Trailered Boat

The following embodiments relate to a self trailered boat which is capable of being towed from one location to another without the need of a conventional boat trailer.

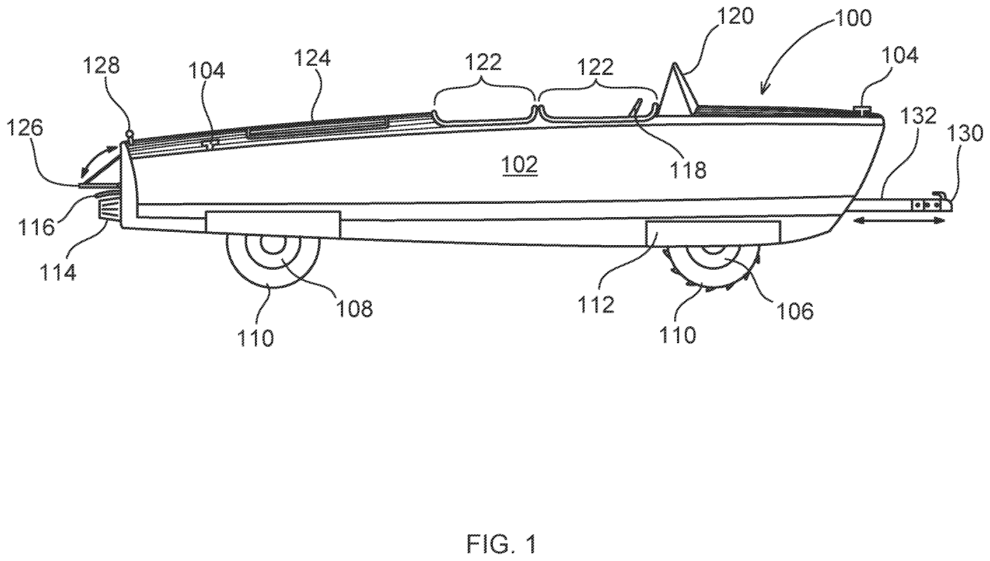

FIG. 1 illustrates a side view of a self trailered boat 100 with the wheels down, according to an embodiment of the disclosure. Self trailered boat 100 shown in FIG. 1 comprises a hull 102. The hull may comprise a metal, polymer, wood, or a combination thereof. In an exemplary embodiment, the hull comprises aluminum. The hull may be a displacement hull or a planing hull. The shape of the hull in FIG. 1 is a V-shaped hull but could be a flat-bottom hull, round-bottom hull, or multi-hulled. In an exemplary embodiment, boat 100 is a runabout. The boat may be a bow rider, center console, cuddy boat, a walkaround boat, or other type of boat.

Boat 100 comprises one or more cleats 104. The one or more cleats may be attached to the hull on the gunwale of the boat on the port or starboard side or both the port and starboard sides. The cleats may be located on the bow or stern of the boat.

Boat 100 comprises a front wheel 106 and two rear wheels 108. The front wheel may be manipulated by rotating the steering wheel 118 when in taxiing mode. In some embodiments, the boat may comprise two front wheels and a single rear wheel. The wheels may be part of a suspension system. The suspension system may further comprise springs, shock absorbers, stabilizers, or other components.

The wheels 106, 108 may further comprise a coating or cover 110, such as a rubber tire or other polymeric material, to provide traction for the wheels to grip a road, boat ramp, or other surface. One or more of the wheels may comprise paddle tires for use in muddy or sandy locations and conditions. In an exemplary embodiment, only the front wheel 106 comprises a paddle tire as illustrated in FIG. 1 which can be retracted during towing mode. In some embodiments, the front wheel may be larger than the rear wheels to aid in moving the boat in wet, sandy, or other difficult conditions.

In an exemplary embodiment, the wheels may be retracted into the hull of the boat into wheel cavities. The wheels may be retracted into the wheel cavities of the hull or moved out of the wheel cavities of the hull by a hand crank, electric motor, hydraulic, hinge, or pneumatic lift system. The front or rear wheels may be raised or lowered to add in hitching the boat to a transporting vehicle. The boat further comprises wheel cavity doors 112. The wheel cavity doors may also be referred to as wheel cavity covers. The wheel cavity doors may also be moved using a hand crank or motor when a user desires to move the wheels into and out of the wheel cavities. The wheel cavity doors may provide a water-tight seal to prevent water from entering the wheel cavities while the boat is in a body of water. The doors 112 may comprise rubber gaskets or O-rings to provide a seal.

In some embodiments, the front wheel may be powered and rotated by an electric motor, an internal combustion engine or a hybrid engine to propel the boat on land. In other embodiments, the rear wheels may be powered and rotated by an electric motor, an internal combustion engine or a hybrid engine to propel the boat. In still other embodiments, the front and rear wheels may be powered by an electric motor, an internal combustion engine or a hybrid engine to propel the boat, The electric motor may be powered by one or more lithium (Li) ion rechargeable battery packs. The battery packs comprise two or more Li ion rechargeable battery cells. The cells may comprise a LiCoO₂, LiFePO₄, LNiMnCoO₂, LiMn₂O₄, or LiNiCoAlO₂-based cell or combinations thereof. Each wheel may be powered with a wheel hub motor. The wheel hub motors may operate independently or in unison with the other wheels.

One or more of the wheels preferably comprises a braking system. In an exemplary embodiment, only the front wheel comprises a braking system so that the boat can be stopped by a user when being propelled by the wheels. The braking system may comprise disc or drum brakes.

In the embodiments where the boat can be self-propelled in taxiing mode, it is desirable to include a transmission that facilitates a towing mode, by disengaging the motor when towing or at least has a free-wheel or one-way bearing as part of the mechanism.

Boat 100 comprises a device to propel the boat through water. The device may be an inboard, outboard, or inboard-outboard (i.e., stern-drive) engine. The engine may be powered by an engine power system such as an electric motor or an internal combustion engine. In an exemplary embodiment, the engine is a jet drive system which creates a jet of water to propel the boat. FIG. 1 illustrates an inboard jet drive motor located in the hull 102 (not shown) that drives an impeller to move water out of a waterjet outlet 114. The boat may further comprise an accelerator foot pedal for controlling the speed of the impeller. When downward pressure on the accelerator foot pedal is released, the impeller is stopped. The steering wheel can move the waterjet outlet to the left or right to steer the boat.

Boat 100 comprises a windshield, such as that shown at 120. The windshield can be removed if desired by a user. The windshield may comprise glass or a polymer such as polycarbonate or poly(methyl methacrylate) (PMMA).

Boat 100 comprises one or more cockpits 122. The cockpits further comprise one or more seats. The boat in FIG. 1 shows a forward cockpit and rearward cockpit wherein the forward cockpit includes the helm with a steering wheel.

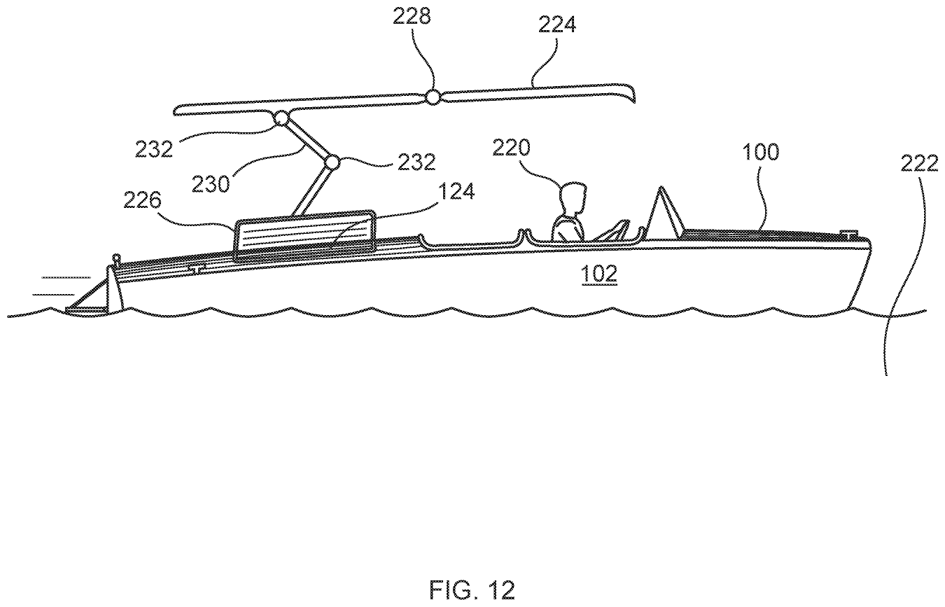

Boat 100 comprises a compartment 124. The compartment includes a removeable cover. The compartment may be used for storage. The compartment may be used to store a sunshade that can be opened to at least partially cover and provide shade to the one or more cockpits. FIG. 12 illustrates a self trailered boat with an expanded sunshade 224, according to an embodiment of the disclosure. The sunshade may be comprised of a flexible material such as cloth or a synthetic polymer. The doors 226 to compartment 124 are opened to expand and open the sunshade. The sunshade may be expandable to be raised and opened to a shading position and provide shade and may be lowered and collapsible to be stored in the compartment in a retracted position. The sunshade comprises a hinge 228 so that it can be folded up to be able to be easily stored in the compartment. The sunshade comprises an actuator to raise and lower the sunshade by expanding and contracting the accordion-like frame 230. The frame comprises one or more hinges 232 to allow the frame to be extended and collapsed out of and into the compartment 124. The actuator may be an electric motor or a hand-operated crank. The compartment may also be used as an access to an inboard motor or further seating.

Boat 100 comprises a swim deck 126. The swim deck may be raised and lowered between an up or down position as denoted by the double-headed arrow in FIG. 1. The swim deck may have a locking device to hold the swim deck in the down or up position.

Boat 100 comprises a tow bar 128. The tow bar may be optional and removeable. The tow bar may be used to tow skiers, wake boarders, rafts, or other types of recreational equipment.

Boat 100 comprises a trailer coupler 130. The trailer coupler is used to link to a hitch, such as a ball hitch, mounted to a vehicle. The trailer coupler further comprises a lock to secure to the hitch of a towing vehicle. The trailer coupler may also be a collar style sleeve-lock A-frame coupler, universal adjustable coupler, universal A-frame coupler, universal A-frame Fas-Lock coupler, universal megahitch combo VLT coupler, adjustable rigid mount trailer coupler, or a straight tongue coupler. The trailer coupler is attached to a shaft 132 wherein the shaft may be retracted into the hull of the boat or may be extended from the hull of the boat as denoted by the double-headed arrow. The trailer coupler and shaft together are referred to as a trailer tongue. When the boat is in towing mode, the trailer tongue is extended to an extended position towing position wherein the trailer coupler can be coupled to a vehicle hitch. When the boat is in boating or recreation mode, the trailer tongue can be retracted into a trailer tongue cavity to a retracted position in the hull of the boat. Extending and retracting the trailer tongue between the towing and retracted boating positions may be carried out with an actuator such as an electric motor or hand-operated crank. Extending and retracting the trailer tongue may also be carried out manually by pulling or pushing the trailer tongue out of or into the trailer tongue cavity. The boat may further comprise a door with a water-tight seal to prevent water from entering the compartment storing the trailer tongue.

When the boat is in towing mode, all three wheels may be extended and disengaged such that the wheels can be turned without resistance or damage to the driving motor or drive train. In a preferred embodiment, only the rear two wheels are extended while the front wheel is retracted into the wheel cavity in the hull of the boat during towing mode. The front wheel is movable between an extended taxiing or towing position and a retracted boating position. The two rear wheels are movable between an extended towing position and a retracted boating position. This may be carried out by first hitching the boat to the towing vehicle followed by retracting the front wheel wherein the boat is only resting on the two rear wheels and the hitch of the towing vehicle.

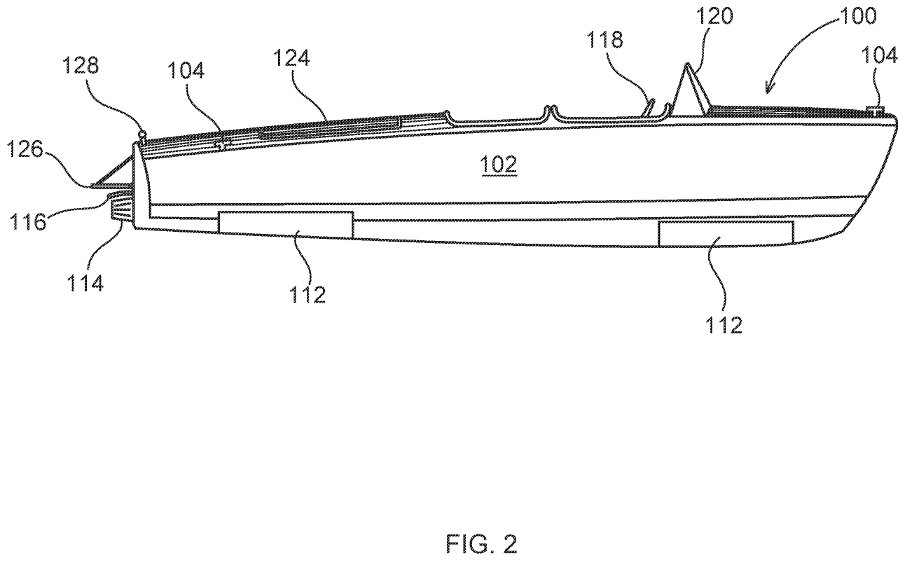

FIG. 2 illustrates a side view of a self trailered boat 100 with the wheels up, according to an embodiment of the disclosure. FIG. 2 illustrates how the wheels may be retracted into wheel cavities in the hull and enclosed by doors 112. This is considered the boating or recreation mode of the boat.

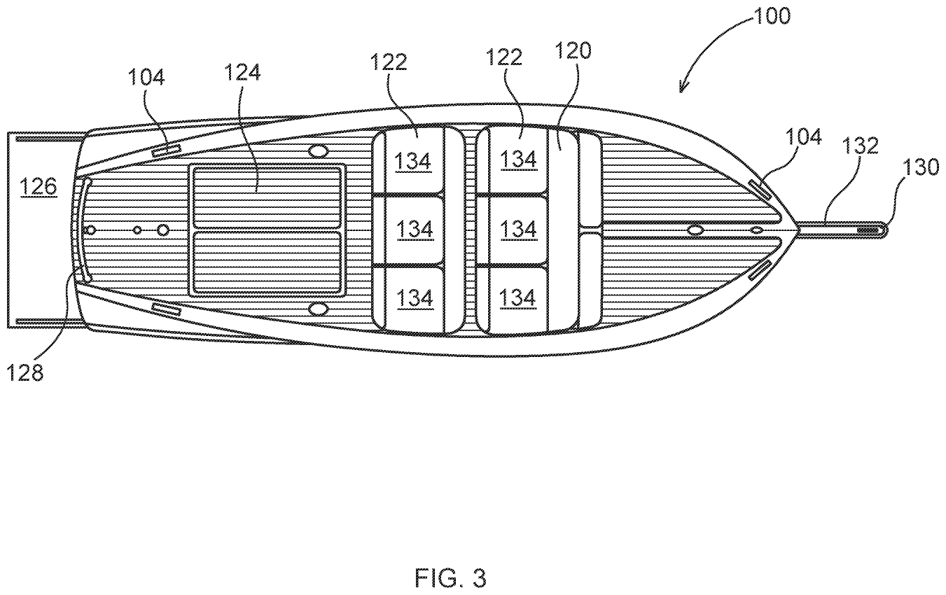

FIG. 3 illustrates an overhead view of a self trailered boat 100, according to an embodiment of the disclosure. This view further illustrates the cockpit area 122. The cockpit 122 further comprises three seats 134 per cockpit. In other embodiments, each cockpit could comprise one or more seats. Compartment 124 comprises two doors though the compartment may comprise only one door. This view also illustrates the swim deck 126 is down and the trailer coupler 130 and trailer coupler shaft 132 is extended.

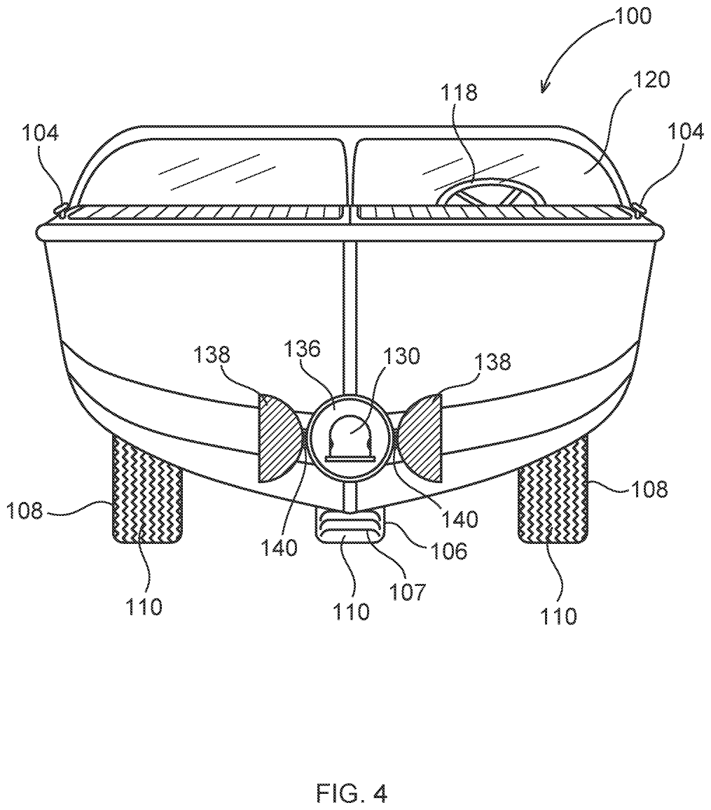

FIG. 4 illustrates a front view of a self trailered boat 100, according to an embodiment of the disclosure. This view further illustrates the trailer coupler 130 and trailer tongue cavity 136. A circular-like trailer tongue compartment is shown but the cavity may be other shapes such as square or oval-like. The trailer tongue compartment may comprise one or more doors 138. The doors may be attached by a hinge 140 or other flexible device. The doors may be opened in towing mode to extend the trailer tongue to be linked to a vehicle. The doors may be closed so that the boat is in boating or recreation mode. The doors may comprise a rubber gasket or O-ring such that when the doors are closed, the doors form a water-tight seal.

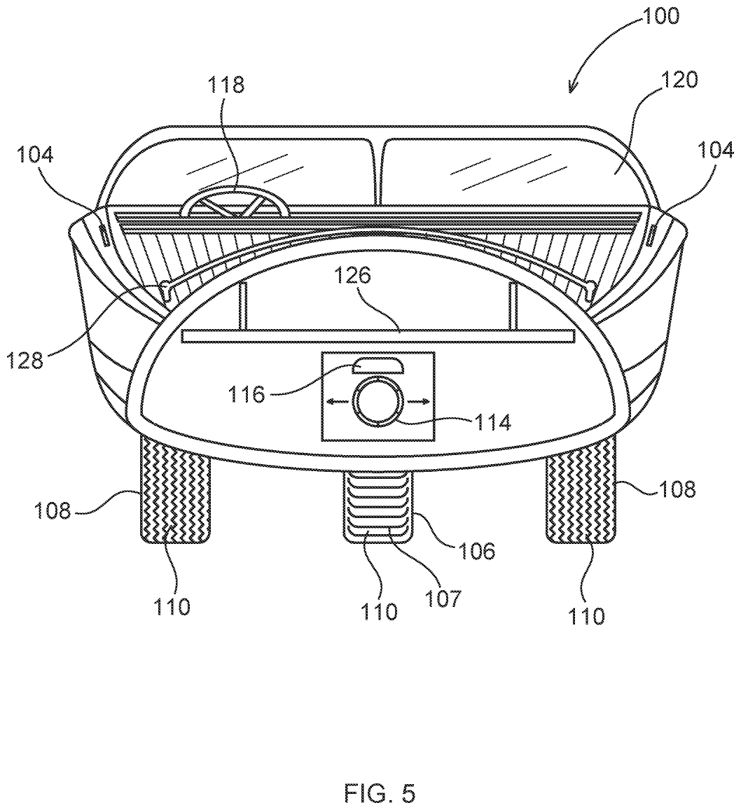

FIG. 5 illustrates a rear view of a self trailered boat 100, according to an embodiment of the disclosure. This view further illustrates the waterjet outlet 114 and shroud 116. The arrows to each side of the outlet illustrates how the outlet may be moved side-to-side by the steering wheel. The shroud may also move side-to-side in coordination with the outlet. FIGS. 4-5 illustrates another view of paddle tire 106 on the front wheel showing the shape of the paddle-shaped tread 107.

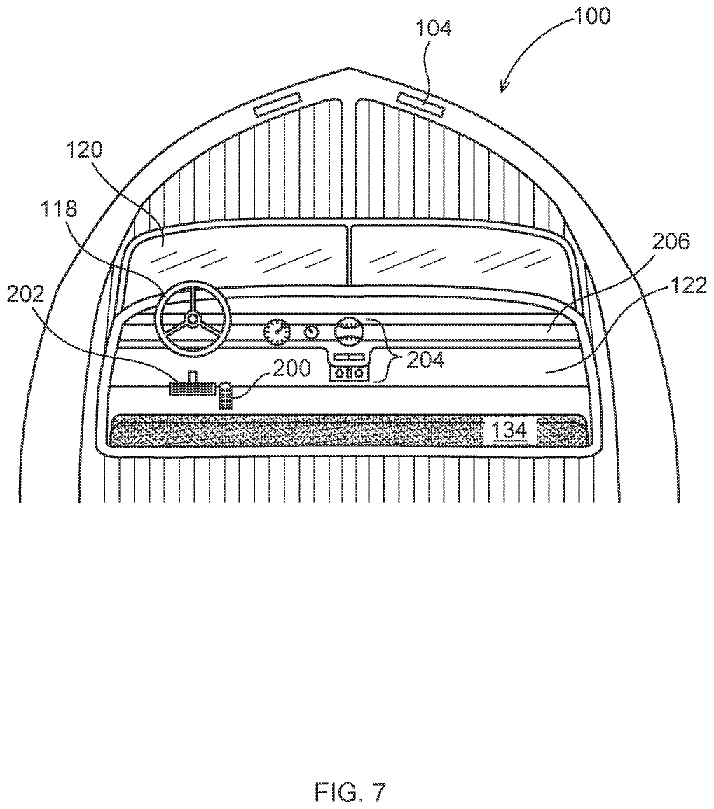

FIG. 7 illustrates the cockpit area 122 of a self trailered boat 100, according to an embodiment of the disclosure. The cockpit comprises the helm area of the boat. The helm comprises a steering wheel 118, a first pedal that is referred to as a power pedal 200, brake pedal 202, controls 204, and dashboard 206. In this embodiment, the layout and design of the helm is similar to a vehicle such as a car or truck. This design may make it simpler and more familiar to drive by a user, especially for a novice boater. When the power pedal is depressed by a user, an engine power system provides power to an engine to propel the boat. When the foot of the user is removed from the power pedal it cuts power from the engine power system to the engine of the boat.

The controls are mounted into the dashboard. In other embodiments, the controls may be mounted in a console that is attached to the floor of the cockpit. The controls may comprise speedometer, depth, GPS (Global Positioning System) location device, battery charge, odometer, power, or other controls, The controls may comprise a switch to raise or lower the suspension or one or more of the wheels into and out of the wheel cavities. The controls may comprise a switch to raise or lower a sunshade. The controls may comprise a switch to move the trailer togue into and out of the trailer tongue cavity.

### Foot Pedal Braking System

The following embodiments relate to a foot braking system for a self trailered boat disclosed herein. In other embodiments, the disclosed foot braking system may be used for a non-self trailered boat.

The boat 100 further comprises a movable shroud 116. The shroud is part of the boat braking system. The boat braking system may be controlled by a second foot pedal or throttle lever. For example, as the second foot pedal is depressed, power is cut to the engine to slow down or stop the boat. As the foot pedal is depressed further, the shroud moves over the jet drive outlet 114 and the engine power is reapplied wherein the jet of water is redirected by the shroud towards the front of the boat which applies a reverse thrust. This may be used to not only stop the boat, but also to move the boat in a reversed direction.

The use of a brake pedal to slow or stop the boat in boating mode provides an important advantage for this preferred embodiment. Particularly for those not as experienced in piloting boats, it increases familiarity and thus safety for the user to use a brake pedal to stop the boat, just like in an automobile. This is particularly true for the boat that can be taxied under its own power. Thus, the user can use a brake pedal for a first braking system to stop the boat in taxiing mode, just like he would use a brake pedal to stop an automobile. To use that same pedal to stop the boat in a second brake system in boating mode makes it even simpler and safer to operate in boating mode. The first and second brake systems are automatically selected depending on whether the boat is taxiing or moving in water. The first brake system may be selected when the front and rear wheels are in the extended position and the second brake system may be selected when the front and rear wheels are in the retracted position.

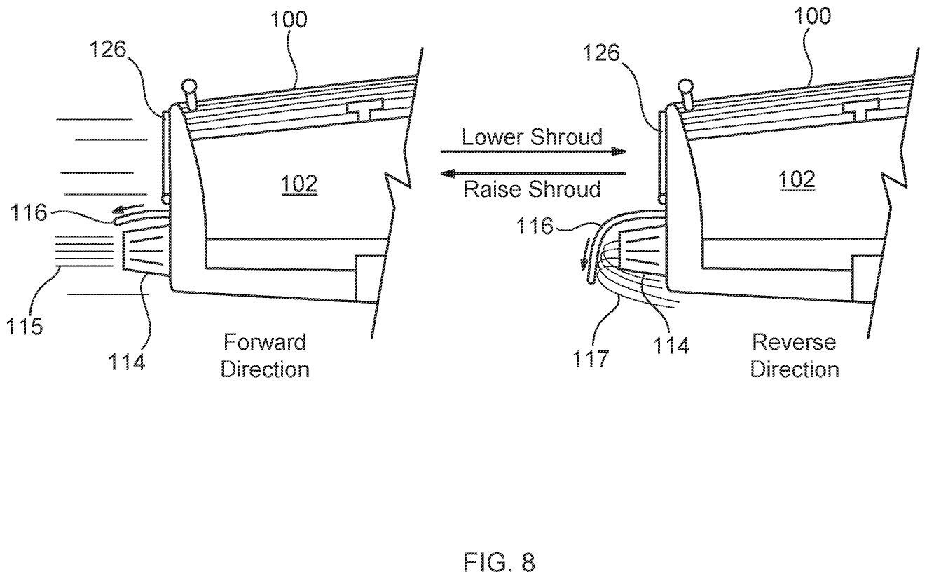

FIG. 8 illustrates a close-up of a jet drive motor in forward and reverse operation in a self trailered boat 100, according to an embodiment of the disclosure. The image to the left in FIG. 8 illustrates a self trailered boat 100 going in a forward direction. This is shown by the waterjet 115 that is emitted from the outlet of the jet drive engine 114. The shroud 116 is in a retracted position. When the shroud is lowered over the outlet as shown in the image to the right in FIG. 8, the shroud redirects the waterjet 117 to reverse the water flow towards the front of the boat. This forces the boat to move in a reverse direction. To stop the boat from going in the reverse direction, the shroud can be raised. This process can be repeated as desired by the user. The moveable shroud may be controlled by actuating a foot pedal.

In alternative embodiments, the boat can be slowed or stopped by redirecting the thrust provided by the engine. For example, in a jet boat, the nozzle can be reversed in direction, or the jetted water can be diverted through braking nozzles that point toward the front of the boat. In a propeller driven boat, the rotation of the propeller can be reversed. Alternatively, the direction of the shaft on which the propeller rotates can be reversed so that the thrust is applied toward the front of the boat.

In some embodiments, the boat further comprises a propeller and rudder system. The rudder can be manipulated by a user using the steering wheel to steer the boat when in boating or recreation mode.

In taxiing mode, when the wheels are extended, the steering wheel is preferably used to move a steerable front wheel. In some embodiments, the steering wheel moves both the front wheel and rudder at the same time in boating or taxiing mode. Rotation of the front wheel or the rear wheels or all of the wheels can be stopped by the braking system. If the boat is equipped with a jet drive system instead, the steering wheel may move the front wheel and waterjet outlet 114 simultaneously in boating or taxiing mode. In boating mode, when the user turns the steering wheel to move the jet drive back and forth, the front wheel may also be turning left or right while in the wheel cavity.

The brake pedal 202 may be used to stop the boat or make the boat reverse direction. This may be done by first having the user remove their foot from the power pedal 200 to cut the power to the engine, then depressing the brake pedal to make the shroud 116 move over the jet drive outlet 114 and reapply power to the engine where the water jet is redirected to the front of the boat by the shroud to either stop or reverse the direction of the boat. In some embodiments, a more traditional throttle lever may be installed in the helm area instead of a brake and power pedal. Pushing the lever forward increases power to the engine while pulling it back gradually decreases and eventually cuts power to the engine. Further pulling back the throttle moves the shroud over the jet drive and redirects the waterjet towards the front of the boat to reverse the direction of the boat. The shroud may also be referred to as a diverter as the shroud diverts the waterjet from the rear to the front of the boat.

In other embodiments, a moveable shroud may also be used in combination with a propeller and rudder system. A foot brake pedal may be depressed which decreases power and eventually cuts power to the propeller. As the user further depresses the brake pedal, the shroud is moved over the front of the propeller and the power to the engine is reapplied such that the water moved by the propeller is redirected towards the front of the boat to either stop the boat or move the boat in reverse.

In some embodiments, a foot brake pedal may be used with a propeller and rudder system without the need of a moveable shroud. A foot brake pedal may be depressed which decreases power and eventually cuts power to the propeller. As the user further depresses the brake pedal, the rotation of the propeller may be reversed to direct water to the front of the boat to either stop the boat or move the boat in the reverse direction.

### Extendable Trailer Tongue

The following embodiments relate to a trailer tongue to hitch the boat to a transporting vehicle such as a car or truck.

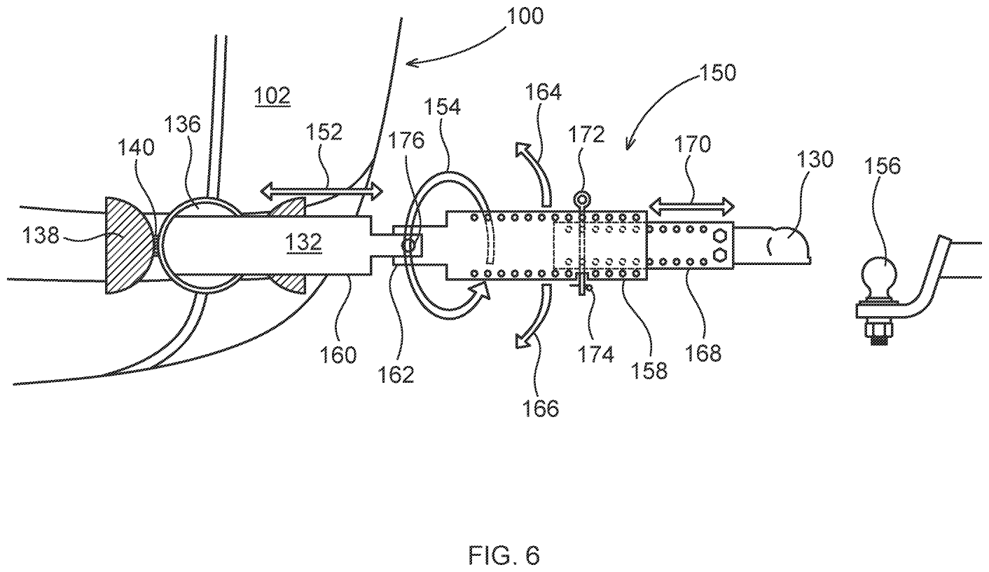

FIG. 6 illustrates a view of a trailer tongue 150 for a self trailered boat 100, according to an embodiment of the disclosure. The trailer tongue 150 can be moved into and out of a cavity 136 located in the hull of the trailer-less boat as denoted by double-headed arrow 152. In this view, multiple capabilities of the trailer tongue are further disclosed. The trailer tongue is movable between an extended towing position and a retracted boating position. When hitching the self trailered boat to a vehicle, it is desirable for the boat to be re-hitched to the transporting vehicle in a quick and efficient manner. The re-hitching process can be difficult if the boat and transporting vehicles are on uneven ground, the trailer coupler and hitch are at unequal heights, in a crowded boat launch area, or if there is only one user. During transport, it is also ideal for there to be flexibility in the hitch system.

For the trailer-less boat to be easily hitched to a transporting vehicle, it is preferred that the trailer tongue can be articulated in multiple directions, heights, and lengths to make it easy to or aid in and couple to a hitch 156 mounted to the transporting vehicle. Thus, it is preferred that the trailer tongue can also rotate such as in a high angular rotation around an axis of rotation, such as 360° as shown by circular arrow 154. The trailer tongue includes a second section 158 that is attached to a first section 160 by a swivel linkage 162, to allow for the rotation. Additionally, the swivel also allows for up 164 and down 166 movement of the second section 158 and coupler 130 at joint 176 so that the trailer tongue can be bent. The joint can be bent in the range of about 0-90° to aid in connecting to the hitch of a towing vehicle.

The second section 158 also has a retractable component 168 and the coupler 130 that links with the hitch 156 of the transporting vehicle. The retractable component can extend or retract 170 into the second section in a telescoping manner. The retractable component may also be referred to as a telescoping extension. This is so that when a transporting vehicle backs up, it does not have to back to a precise distance but still able to easily extend the coupler to the required distance to link. This is especially useful for a single user who cannot accurately tell how much to back the transporting vehicle or to drive the boat near the transporting vehicle. Ideally the second section can extend or retracting from about one to two feet. The multiple positions that are possible with the trailer coupler makes it easy to hitch the trailer-less boat to a vehicle. The second section and retractable portion 168 may be locked into place, such as using a hitch pin 172 and cotter key 174 or another device.

Preferably, any of the movements can be locked into place once the boat is hitched to the vehicle. In some instance, it may be preferred that some of the movements are not locked and are instead allowed to flex to account for unevenness of the road and vibrations from transportation from one location to another.

In another embodiment, the front wheel suspension can be raised and lowered in order to raise and lower the front of the boat to make it simpler to link a trailer coupler to the hitch of a towing vehicle.

It should be noted that the trailer tongue invention disclosed herein may also be used in other non-boat applications such as trailers, recreational vehicles (RVs), trucks, cars, semis, wagons, tractor-trailers, lorries, tractors, and other types of transports.

### Towing a Self Trailered Boat

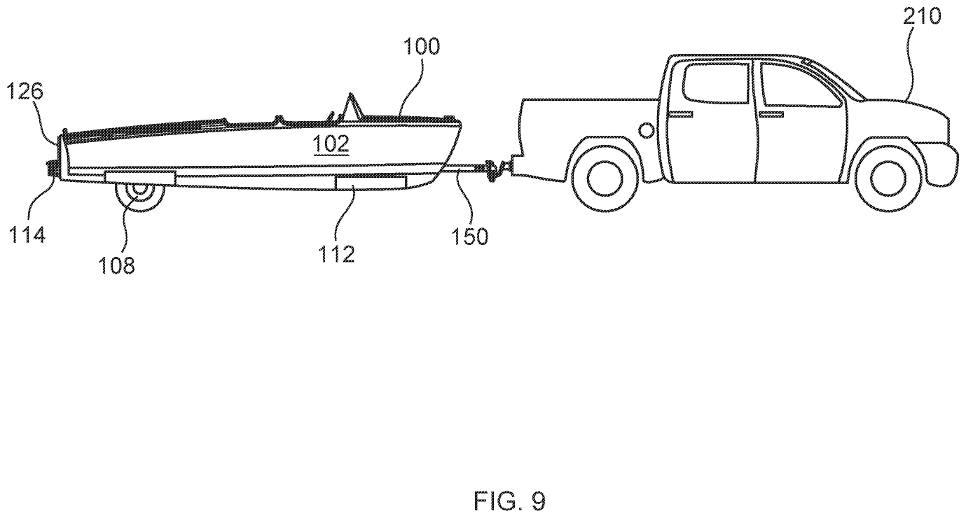

FIG. 9 illustrates a view of a self trailered boat 100 hitched to a vehicle, according to an embodiment of the disclosure. This illustrates a preferred towing method for towing the self trailered boat from one location to another. In this method, the boat is hitched to a towing vehicle 210. The front wheel is then raised into the wheel cavity and the wheel cavity door 112 is closed. The boat rests on the hitch of the towing vehicle and the rear wheels 108 that are in the extended position.

The self trailered boat 100 can be transported from a location to a body of water and operated as follows. In parked mode, the boat typically sits at its storage site, such as in the garage or driveway of the user. The boat may rest on its wheels or may rest on jacks or other supports. Typically, to save space, the trailer tongue will be retracted in the parked mode. To hitch the boat to a towing vehicle, the boat may enter taxiing mode if its needs to move to a spot where it can be hitched.

To enter the towing mode, the tongue is extended, and the wheels extended, if not already extended. The trailer coupler is connected to a hitch that is mounted to a transporting vehicle. Preferably, the coupling to the towing vehicle will include an electric coupling of the brake lights and turn signals of the towing vehicle, to comply with all safety and traffic regulations. In towing mode, the front wheel should be locked in the straight position, i.e., pointed in the direction of travel.

The transporting vehicle typically tows the self trailered boat in towing mode to a parking lot near a boat ramp at a body of water. The trailer coupler is disconnected from the hitch. The trailer tongue is retracted back into the trailer tongue cavity. The doors to the trailer tongue cavity are closed and secured. The boat then enters the taxiing mode, and the user drives the boat to the boat ramp and into the body of water. Alternatively, the boat is light enough that the user can simply push or pull the boat from the unhitching spot to the boat ramp.

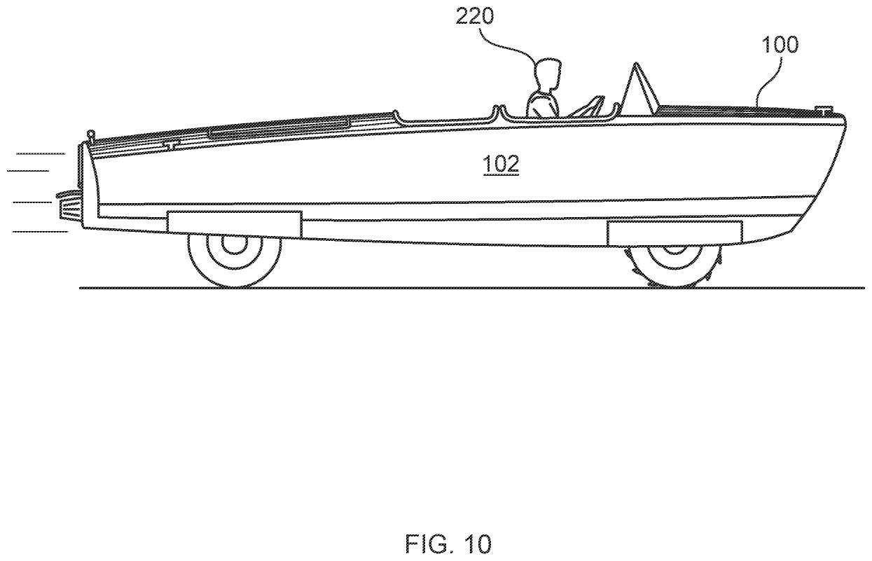

FIG. 10 illustrates a self trailered boat 100 in taxiing mode, according to an embodiment of the disclosure. In taxiing mode, a user 220 may drive the boat to a boat ramp, to a towing vehicle in a parking lot, to a garage or other storage facility or other desired location. Preferably, movement in taxiing mode is made possible by one or more motors that power one or more of the wheels on a surface.

An advantage of the preferred embodiment with a self-propelled, self trailered boat is that, not only can it be taxied when it reaches the lake or river where it will be launched, it can also be taxied around the place where it will be parked for storage between uses. In other words, it is not necessary for the towing vehicle to back it into a storage space, which, in and of itself, can present a challenge, depending on the size and shape of the storage space. In this preferred embodiment, the boat can simply be taxied into its storage spot. In some embodiments, the steering and speed of the boat and raising and lowering of one or more of the wheels can be controlled remotely or autonomously while in taxiing mode. The boat can be controlled remotely using a wireless or wired connection from a handheld control device to the boat. In other embodiments, the distance between the storage spot and the water is short enough that the boat can be taxied directly from one to the other, i.e., without being towed.

Upon arriving in the water, to enter the boating mode, the wheels are retracted into wheel cavities in the hull of the boat by an electric motor or hand crank. The doors to the wheel cavities are closed. The steering wheel is disengaged from the drive train of the front wheel and engaged with the rudder. The user starts the engine and drives the boat across the body of water.

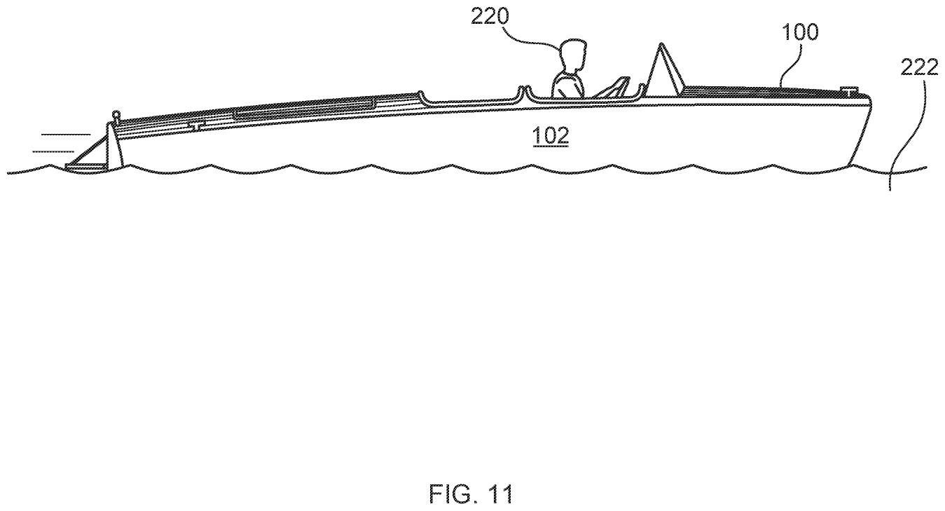

FIG. 11 illustrates a self trailered boat 100 in boating mode, according to an embodiment of the disclosure. In boating mode, all of the wheels are retracted, movement is made possible by an engine, such as a jet drive engine, and is driven by a user 220 through a body of water 222.

In an alternative embodiment, the boat is a sailboat, and the sail is used to move the boat across the water. In the sailboat embodiment, the boat further includes a moveable fin keel, that can be raised in the taxiing and towing modes but lowered in the boating mode to give stability to the boat when sailing.

### Methods to Manufacture the Components of the System

Embodiments of the present invention allow the boat to be fabricated with cheaper and faster processing methods than traditional boats. The boat may be made from stainless steel or aluminum, reducing the need to cover the material with an expensive coating process. A tab and slot method of fabrication may be used to assemble the boat, providing an efficient and precise way to build the boat. Further, non-additive laser welding may be used to produce high quality welds, to speed up manufacturing, and to aide automation. It also reduces material costs, provides smokeless manufacturing, which is less hazardous, and reduces and cleanup costs.

The preferred method of manufacturing the boat of the present invention involves a tab and slot method, whereby a hull is constructed from metal pieces cut from flat stock, such as aluminum, an aluminum alloy or stainless steel. This technique has been well described in the following U.S. Patents, the entire disclosure of which are incorporated by reference: 8,398,159; 9,387,886; 9,802,663; and 10,604,192. By one method, a hull is constructed by the tab and slot method described in these patents and then a skin, such as a molded fiber reinforced polymer or a metal, such as an aluminum alloy or stainless steel, is attached thereto.

All patents, published patent applications, and other publications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A boat comprising:
a hull;
a steering wheel;
an engine power system comprising a first foot pedal that is operated by a user's foot to control the boat's speed through water; and
a braking system comprising a second foot pedal that is depressed by the user's foot to slow or stop the boat.

2. The boat of claim 1, wherein the braking system further comprises a moveable shroud that is moved over a jet drive outlet or a propeller to reverse water flow and slow or stop the boat.

3. The boat of claim 2, wherein the moveable shroud is operated by the second foot pedal.

4. The boat of claim 3, wherein the distance the second foot pedal is depressed determines the amount of reverse water flow is produced by the moveable shroud.

5. The boat of claim 3, wherein removing the user's foot from the first foot pedal stops the engine power system.

6. A towable boat comprising:
a hull;
a front wheel movable between an extended position and a retracted boating position;
two rear wheels, each of which is movable between an extended towing position and a retracted boating position;
a motor to drive at least one of the front or two rear wheels, whereby the boat can be taxied to a spot where it enters the water; and
a brake foot pedal, operating both a first brake system to slow or stop the boat when taxiing and a second brake system to slow or stop the boat when boating.

7. The boat of claim 6, wherein the first and second brake systems are automatically selected depending on whether the boat is taxiing or boating.

8. The boat of claim 6, wherein the first brake system is selected when the front and rear wheels are in the extended position and the second brake system is selected when the front and rear wheels are in the retracted position.

9. The boat of claim 6, further comprising an impeller for moving the boat in water and an accelerator foot pedal for controlling the speed of the impeller.

10. The boat of claim 9 , wherein, when downward pressure on the accelerator foot pedal is released, the impeller is stopped.

11. The boat of claim 6, wherein rotation of the front wheel can be stopped by the braking system.

12. The boat of claim 6, further comprising a trailer tongue movable between an extended towing position and a retracted boating position.

13. The boat of claim 12 further comprising a cavity in the hull and wherein the trailer tongue retracts into the cavity.

14. The boat of claim 6, wherein at least one of the wheels is configured to be rotated by a motor to thereby propel the boat when taxiing.

15. The boat of claim 6 wherein the front wheel is steerable.

16. The boat of claim 6, wherein the braking system comprises a moveable shroud that can be moved over a jet drive outlet or a propeller to redirect water flow to reverse water flow and slow or stop the boat when boating.

17. The boat of claim 16, wherein the moveable shroud can be controlled by actuating the brake foot pedal.

18. The boat of claim 17, wherein the distance the brake foot pedal is depressed determines the amount of reverse water flow is produced by the moveable shroud.

19. The boat of claim 6, wherein the hull comprises aluminum.

20. The boat of claim 6, wherein the boat is fabricated by a tab and slot method.
